(19) United States
(12) Patent Application Publication
(10) Pub. No.: US 2012/0323370 A1
(43) Pub. Date: Dec. 20, 2012

(54) OPENING-AND-CLOSING MEMBER CONTROL DEVICE

(75) Inventors: Takeshi NISHIKIBE, Tokai-shi (JP); Kohei KOBAYASHI, Ichinomiya-shi (JP)

(73) Assignee: AISIN SEIKI KABUSHIKI KAISHA, Kariya-shi (JP)

(21) Appl. No.: 13/524,759

(22) Filed: Jun. 15, 2012

(30) Foreign Application Priority Data
Jun. 15, 2011 (JP) 2011-133466

(51) Int. Cl. G05B 15/02

(52) U.S. Cl. 700/275

(57) ABSTRACT

An opening-and-closing member control device for controlling a driving device to operate an opening-and-closing member according to a target speed includes a detection portion detecting an operational state of the driving device during the control, a disturbance determination portion for determining whether a disturbance is generated at the opening-and-closing member, which is applied in the same direction to an operating direction of the opening-and-closing member during an opening-closing operation of the opening-and-closing member, by monitoring at least one of a change in an electric signal and in an operation speed of the opening-and-closing member generated relative to the target speed, and a threshold value changing portion for switching an entrapment threshold value when the disturbance determination portion determines that the disturbance is generated. Whether an external object is entrapped at the opening-and-closing member is detectable by comparing an electric signal obtained by the detection portion and the entrapment threshold value.

### CROSS REFERENCE TO RELATED APPLICATIONS

This application is based on and claims priority under 35 U.S.C. §119 to Japanese Patent Application 2011-133466, filed on Jun. 15, 2011, the entire content of which is incorporated herein by reference.

### TECHNICAL FIELD

This disclosure generally relates to an opening-and-closing member control device for controlling an operation of an opening-and-closing member.

### BACKGROUND DISCUSSION

A known opening-and-closing member control device which automatically operates or assists an opening/closing operation of an opening-and-closing member, for example, a slide door, a door at the back of a vehicle by, for example, a motor is provided for many vehicles. According to the known opening-and-closing member control device, a target speed for each door position is set. Thus, a rotation speed of the motor is increased by enhancing an electric voltage to be applied to the motor when an actual speed of the opening-and-closing member (operation speed of the opening-and-closing member) is less than the target speed, and the rotation speed of the motor is reduced by reducing the electric voltage to be applied to the motor when the actual speed of the opening-and-closing member exceeds the target speed. Accordingly, a smooth opening and closing operation of the opening-and-closing member is ensured.

Further, the known opening-and-closing member control device is provided with a pinch detection function (entrapment detection function) for the purpose of ensuring a safety during the opening-and-closing operation. In case of performing a pinch detection, for example, by an electric current flowing in the motor, according to the known pinch detection function, it is determined that an object is pinched (entrapped) when an electric current value is assumed to be equal to or greater than a threshold value for determining the entrapment, then, for example, a rotation of the motor is reversed.

Notwithstanding, for example, at the beginning of opening the opening-and-closing member, a user may thrust (push firmly) the opening-and-closing member to open. In those circumstances, because a motor output necessary for actuating the opening-and-closing member is temporarily reduced because of the operational force by the user, the electric current flowing in the motor is reduced. Thereafter, when the user reduces the thrusting force (pushing force), the motor output necessary for actuating the opening-and-closing member at the moment increases, thus increasing a level of the electric current at the motor. In those circumstances, depending on the situations, the electric current may exceed the threshold value for the determination of the pinch detection (entrapment detection), which leads to erroneously determine that the object is pinched (entrapped) even when the entrapment is not actually caused.

In order to countermeasure the foregoing problem, JP2005-155126A (hereinafter refereed to as Patent reference 1) discloses a device which sets a threshold value for determining an entrapment to be higher than a normal threshold value for a predetermined period at the beginning of the opening operation of the opening-and-closing member. According to the known construction disclosed in the Patent reference 1, even if a user thrusts (firmly pushes) the opening-and-closing member to open, erroneous determinations of the entrapment of the object can be reduced under the mentioned situations.

In the meantime, during the opening/closing operation of the opening-and-closing member, a disturbance may be applied to the opening-and-closing member, for example, by pushing the opening-and-closing member to the same direction with the operating direction of the opening-and-closing member. However, because the known construction disclosed in the Patent reference 1 is in association with setting the threshold value for determining the entrapment of the object immediately after starting an opening operation of the opening-and-closing member to be higher indiscriminately, the construction of the Patent reference 1 does not serve as a counter measurement for preventing erroneous reversal rotation of a motor because of the disturbance caused during the opening/closing operation of the opening-and-closing member. Further, according to the known construction disclosed in the Patent reference 1, because the threshold value for determining the entrapment of the object is set to be higher without conditions immediately after starting the opening operation of the opening-and-closing member, a detection sensitivity of the pinch detection (entrapment detection) is deteriorated every time immediately after starting the opening operation of the opening-and-closing member.

A need thus exists for an opening-and-closing member control device which is not susceptible to the drawback mentioned above.

### SUMMARY

In light of the foregoing, the disclosure provides an opening-and-closing member control device for controlling a driving device to operate an opening-and-closing member in accordance with a target speed, which includes a detection means detecting an operational state of the driving device during the control, a disturbance determination means for determining whether a disturbance is generated at the opening-and-closing member, which is applied in the same direction to an operating direction of the opening-and-closing member during an opening-closing operation of the opening-and-closing member, by monitoring at least one of a change in an electric signal and in an operation speed of the opening-and-closing member generated relative to the target speed, and a threshold value changing means for switching an entrapment threshold value when the disturbance determination means determines that the disturbance is generated. Whether an external object is entrapped at the opening-and-closing member is detectable by comparing an electric signal obtained by the detection means and the entrapment threshold value.

### BRIEF DESCRIPTION OF THE DRAWINGS

The foregoing and additional features and characteristics of this disclosure will become more apparent from the following detailed description considered with the reference to the accompanying drawings, wherein:

FIG. 1 shows a diagram for an opening-and-closing control device according to an embodiment disclosed here;

FIG. 2 illustrates a waveform diagram showing changes in speed of an opening-and-closing member during an opening/closing operation;

FIG. 3 illustrates a waveform diagram showing changes in an electric current of a motor during the opening/closing operation of the opening-and-closing member;

FIG. 4 is a chart showing conditions by which a generation of a disturbance is determined;

FIG. 5 is a flowchart showing transactions of an entrapment threshold value switching function; and

FIG. 6 is a flowchart showing transactions continued from FIG. 5.

### DETAILED DESCRIPTION

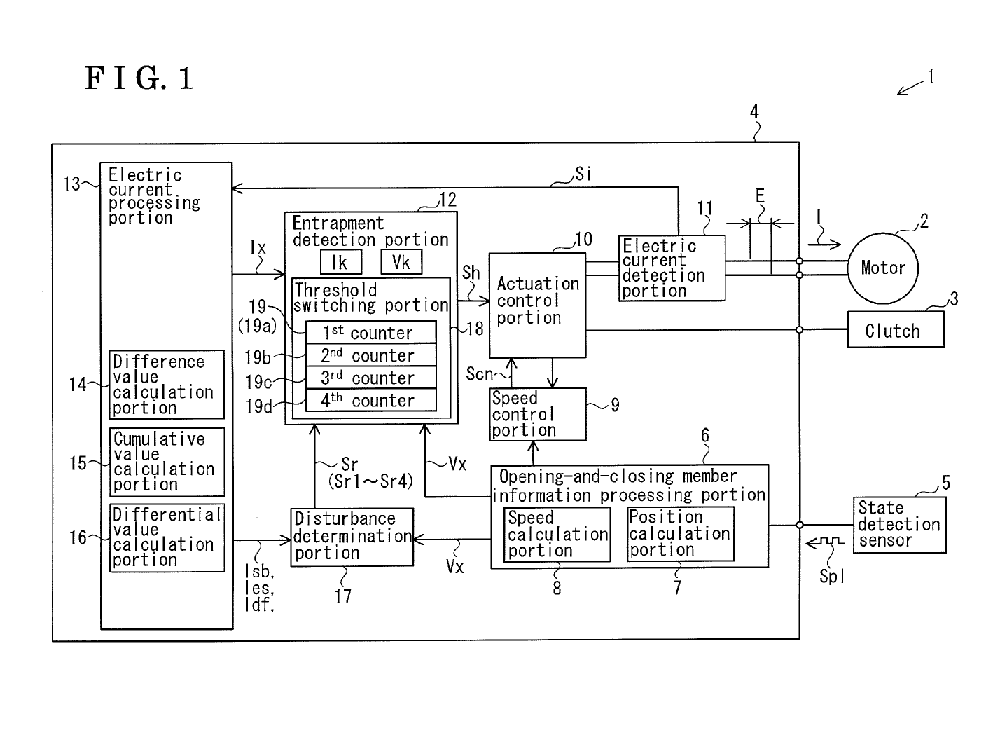

One embodiment of the opening-and-closing member control device will be explained with reference to FIGS. 1 to 6 as follows.

As illustrated in FIG. 1, a powered door opening-closing system 1 for automatically operating an opening-and-closing member or assisting an opening and closing of an opening-and-closing member, for example, a slide door and a back door (a door at the back of a vehicle) is provided at a vehicle. The powered door opening-closing system 1 is configured to open/close the opening-and-closing member with a motor (i.e., serving as a driving device) 2 serving as a drive source, and opens/closes the opening-and-closing member automatically or with light force. Further, the powered door opening-closing system 1 is provided with a clutch 3 for switching a mechanical connection and disconnection between the opening-and-closing member and the motor 2. Thus, in a powered mode where the motor 2 operates the opening-and-closing member, the clutch 3 is engaged (ON), and in a manual mode where the operation of the opening-and-closing member is manually performed, the clutch 3 is disengaged (OFF). The motor 2 serves as a driving device.

The powered door opening-closing system 1 is provided with an opening-and-closing member control device 4 for controlling an opening/closing operation of the opening-and-closing member. The opening-and-closing member control device 4 includes an in-vehicle ECU (Electronic Control Unit). The opening-and-closing member control device 4 is connected to the motor 2 and the clutch 3.

The opening-and-closing member control device 4 includes a speed control function for operating the opening-and-closing member at a target speed (trajectory planning). The speed control function is a type of a feedback control function, which executes a transaction to reduce an operational speed V of the opening-and-closing member (hereinafter referred to as the opening-and-closing member speed V)(also refereed to as the speed V) by reducing the rotation speed of the motor 2 when the opening-and-closing member speed V is enhanced and a transaction for increasing the opening-and-closing member speed V by increasing the rotational speed of the motor 2 when the opening-and-closing member speed V declines during the operation of the opening-and-closing member. The transaction is executed every time the opening-and-closing member speed V changes. Accordingly, the opening-and-closing member is operated at a target speed to ensure smooth opening/closing operation of the opening-and-closing member.

An opening-closing state detection sensor 5 (i.e., also referred to as a state detection sensor) detecting an operational state of the opening-and-closing member is connected to the opening-and-closing member control device 4. The opening-closing state detection sensor 5, for example, includes an encoder, and is configured to output a pulse signal Spl corresponding to an operational state of the opening-and-closing member. The opening-closing state detection sensor 5 is, for example, built-in the motor 2 and detects the operational state of the opening-and-closing member by the detection of the rotation speed of the motor 2.

The opening-and-closing member control device 4 is provided with an opening-and-closing member information processing portion 6 for calculating the opening-and-closing member speed V and a position of the opening-and-closing member (hereinafter refereed to as the opening-and-closing member position N)(i.e., also referred to as position N) on the basis of the pulse signal Spl inputted from the opening-closing state detection sensor 5. The opening-and-closing member information processing portion 6 includes an opening-and-closing member position calculation portion 7 (i.e., also referred to as position calculation portion) calculating the opening-and-closing member position N and an opening-and-closing member speed calculation portion 8 (i.e., also refereed to as a speed calculation portion) calculating the opening-and-closing member speed V. The opening-and-closing member information processing portion 6 serves as a part of a disturbance determination means. The opening-and-closing member speed V serves as an operation speed.

The opening-and-closing member control device 4 is provided with a speed control portion 9 controlling the opening-and-closing member speed V on the basis of various information (i.e., each data of the opening-and-closing member position N and the opening-and-closing member speed V) inputted from the opening-and-closing member information processing portion 6. Further, the opening-and-closing member control device 4 is provided with an actuation control portion 10 for controlling an electric voltage to be applied to the motor 2 (hereinafter referred to as a motor applied voltage E) on the basis of a control command Scn inputted from the speed control portion 9. Thus, in accordance with the motor output required for the actuation of the opening-and-closing member, an electric current (hereinafter referred to as a motor electric current I) flows in the motor 2. The motor electric current I serves as an electric signal.

A target speed of the opening-and-closing member, that is, a speed which the opening-and-closing member should take at each opening-and-closing member position N during the opening/closing operation is pre-stored (pre-registered) in the speed control portion. The speed control portion 9 successively outputs a difference between the target speed and an opening-and-closing member speed value Vx (the opening-and-closing member speed V) calculated by the opening-and-closing member speed calculation portion 8 as the control command Scn to the actuation control portion 10. The control command Scn is a type of a command for eliminating (narrowing) the difference between the target speed and the current opening-and-closing member speed V, and is outputted to the actuation control portion 10 every time calculated in the speed control portion 9. The speed control portion 9 controls the motor 2 by a duty control via the actuation control portion 10.

The actuation control portion 10 is connected to the motor 2 via an electric current detection portion 11 detecting the motor electric current I and is connected to the clutch 3. The actuation control portion 10 controls an actuation of the motor 2 on the basis of the control command Scn inputted from the speed control portion 9. For example, in a case where the current opening-and-closing member speed V is lower than the target speed, a duty ratio of a drive pulse outputted to the motor 2 is increased to increase the motor applied voltage E. On the other hand, in a case where the current opening-and-closing member speed V is higher than the target speed, the duty ratio of the drive pulse outputted to the motor 2 is reduced to reduce the motor applied voltage E. By performing the foregoing transactions consecutively, the rotational operation of the motor 2, that is, the opening-and-closing member speed V is adapted to follow the target speed. The electric current detection portion 11 corresponds to a detection means.

The opening-and-closing member control device 4 includes an entrapment detection function detecting an entrapment of an external object (foreign matter). According to the embodiment, the entrapment detection function determines that the opening-and-closing member entraps an external object in a case where the motor electric current I is assumed to be equal to or greater than an entrapment threshold value Ik for electric current or in a case where the opening-and-closing member speed V is assumed to be less than an entrapment threshold value Vk for speed. When it is detected that the opening-and-closing member entraps the external object, for example, the opening-and-closing member is operated in a reverse direction by rotating the motor 2 in the reversal direction to release the entrapped external object.

In those circumstances, the opening-and-closing member control device 4 is provided with an entrapment detection portion 12 for detecting whether an external object is entrapped (pinched) at the opening-and-closing member. Further, the opening-and-closing member control device 4 is provided with an electric current processing portion 13 calculating a value of the motor electric current I (hereinafter referred to as the driving motor electric current value Ix) on the basis of an electric current detection signal Si inputted from the electric current detection portion 11. The driving motor electric current value Ix corresponds to the electric current value for detecting whether the entrapment of an external object is generated.

The entrapment detection portion 12 compares the driving motor electric current value Ix inputted from the electric current processing portion 13 and the entrapment threshold value Ik for electric current, and recognizes (determines) that the external object is entrapped at the opening-and-closing member when the driving motor electric current value Ix is assumed to be equal to or greater than the entrapment threshold value Ik, thus to output an entrapment detection signal Sh to the actuation control portion 10. Further, the entrapment detection portion 12 compares a value of the opening-and-closing member speed V (hereinafter referred to as the opening-and-closing member speed value Vx) inputted from the opening-and-closing member information processing portion 6 and the entrapment threshold value Vk for speed, and recognizes (determines) that the entrapment of an external object by the opening-and-closing member when the opening-and-closing member speed value Vx is assumed to be equal to or greater than the entrapment threshold value Vk, thus to output the entrapment detection signal Sh to the actuation control portion 10.

The actuation control portion 10 reverses the rotation of the motor 2 at the timing when inputted with the entrapment detection signal Sh from the entrapment detection portion 12, thus moving the opening-and-closing member in a reverse direction. Accordingly, the external object entrapped by the opening-and-closing member is released.

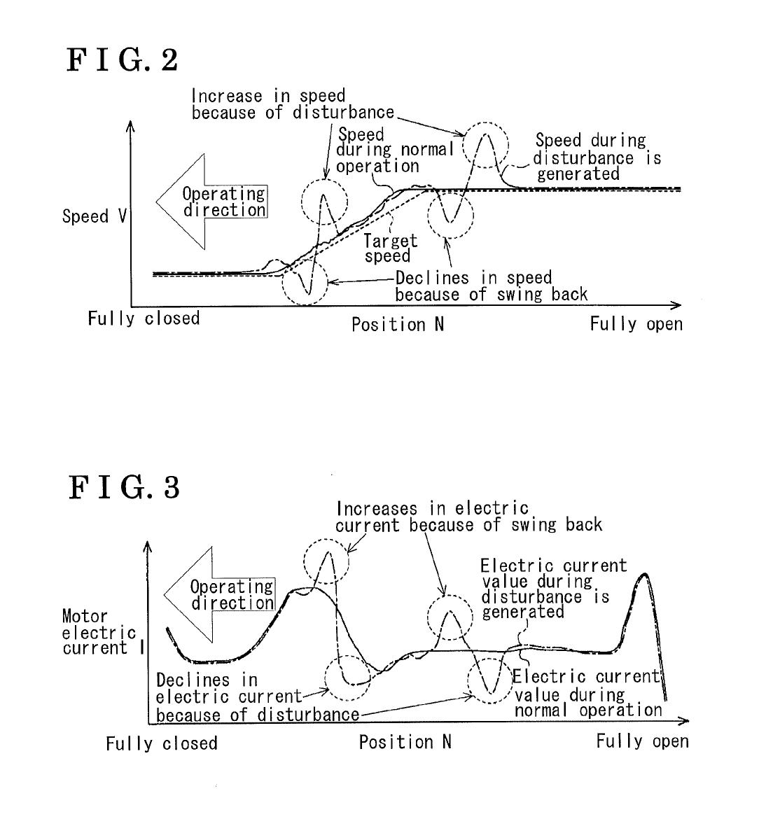

FIG. 2 shows changes in a waveform of the opening-and-closing member speed V when the opening-and-closing member is in operation. FIG. 3 shows changes in a waveform of the motor electric current I when the opening-and-closing member is in operation. FIGS. 2 and 3 show examples that the opening-and-closing member operates from a fully open state to a fully closed state. As shown in FIG. 2, the opening-and-closing member speed V in a normal state, that is, an opening-and-closing member speed during a normal operation (i.e., also referred to as a speed during a normal operation) shows a waveform following the target speed. Further, the motor electric current I during a normal state, that is, an electric current value during a normal operation shows a waveform in which an electric current value is unstable at the beginning, then the electric current value is stabilized, and the electric current is increased immediately before completely closing the opening-and-closing member.

During the opening/closing operation of the opening-and-closing member, a disturbance may be applied to the opening-and-closing member, for example, by pushing the opening-and-closing member in the same direction with the operating direction of the opening-and-closing member. In those circumstances, as shown in FIG. 2, the opening-and-closing member speed V increases temporarily by the disturbance. Further, because the motor output necessary for the actuation of the opening-and-closing member reduces, as shown in FIG. 3, the motor electric current I is reduced. When the speed of the opening-and-closing member increases due to the disturbance, a declined in speed because of the reduction of the motor output (i.e., swing back) is generated at the opening-and-closing member thereafter. Thus, as shown in FIG. 2, because the opening-and-closing member speed V is reduced to increase the motor output necessary for the actuation of the opening-and-closing member, as shown in FIG. 3, the motor electric current I increases.

Namely, when the disturbance is generated at the opening-and-closing member, the opening-and-closing member speed V temporarily increases due to the influence of the disturbance first, then the opening-and-closing member speed V temporarily declines due to the swing back, Meanwhile, when the disturbance is generated at the opening-and-closing member, the motor electric current I is temporarily decreases due to the influence of the disturbance first, then the motor electric current I temporarily increases due to an increase in necessary motor output for the actuation (swing back).

As shown in FIGS. 2 and 3, when the disturbance is generated at the opening-and-closing member, because the driving motor electric current value Ix increases temporarily, the driving motor electric current value Ix may become equal to or greater than the entrapment threshold value Ik even if any external object is not entrapped at, or not pinched by the opening-and-closing member. In other words, an occurrence of the entrapment of the external object may be erroneously determined. FIGS. 2 and 3 shows examples where the disturbance is generated twice during a single operation of the opening-and-closing member.

In response to the foregoing, the opening-and-closing member control device 4 of the embodiment includes an entrapment threshold value switching function for temporarily increasing a level of the entrapment threshold value Ik. As shown in FIG. 2, because the opening-and-closing member speed V temporarily increases when the disturbance is generated, whether the disturbance is generated can be detected by monitoring the increase in the opening-and-closing member speed V. Further, because the motor electric current I temporarily decreases due to the generation of the disturbance, as shown in FIG. 3, the disturbance is detectable by the detection of the declination of the electric current. The entrapment threshold value switching function according to the embodiment determines whether the disturbance is generated by monitoring a temporal increase in the opening-and-closing member speed V or a declining change of the electric current, and when it is determined that the disturbance is generated, the entrapment threshold value Ik is switched from a normal value to an expanded value (a higher value).

In those circumstances, the electric current processing portion 13 is provided with an electric current difference value calculation portion 14 (i.e., also refereed to as a difference value calculation portion) which obtains the driving motor electric current value Ix at a reference position and calculates a difference (i.e., electric current difference value Isb) between a reference electric value Ibs, which is obtained at the reference position, and a current electric current value Inw. The electric current difference value calculation portion 14 constantly calculates the electric current difference value Isb during an opening and closing operation of the opening-and-closing member. According to the embodiment, the reference position is defined as a position at which the speed of the opening-and-closing member is assumed to be stable. The reference electric current value Ibs is defined as the driving motor electric current value Ix when the opening-and-closing member is positioned at the reference position. The electric current difference value calculation portion 14 serves as a part of a disturbance determination means. The reference electric current value Ibs serves as a reference electric signal. The current electric current value Inw serves as a current electric signal. The electric current difference value Isb serves as a difference.

The electric current processing portion 13 is provided with an electric current cumulative value calculation portion 15 (i.e., also referred to as a cumulative value calculation portion) which obtains a difference between the current electric current value Inw and an electric current value Ibf at predetermined number of times before of the driving motor electric current value Ix and add-ups, or integrates the differences by predetermined number of times to calculate an cumulative value (electric current cumulative value Ies). The electric current cumulative value calculation portion 15 constantly calculates the electric current cumulative value Ies during an opening/closing operation of the opening-and-closing member. According to the embodiment, the electric current value Ibf at predetermined number of times before is applied when calculating the electric current cumulative value Ies for the purpose of including (reflecting) a moving time (a moving period of time) of the opening-and-closing member or a moving distance of the opening-and-closing member in (on) the electric current cumulative value Ies. The electric current cumulative value calculation portion 15 serves as a part of a disturbance determination means. The electric current value Ibf at predetermined number of times before serves as an electric signal at predetermined timing before. The electric current cumulative value Ies serves as a cumulative value.

The electric current processing portion 13 is provided with an electric current differential value calculation portion 16 (i.e., also referred to as a differential value calculation portion) for calculating a differential value of the driving motor electric current Ix (i.e., electric current differential value Id). The electric current differential value calculation portion 16 obtains a differential value of the electric current value Ibf at predetermined number of times before and the current electric current value Inw to calculate as the electric current differential value Idf. The electric current differential value calculation portion 16 constantly calculates the electric current differential value Idf during an opening/closing operation of the opening-and-closing member. According to the embodiment, the electric current value Ibf at predetermined number of times before is applied to calculate the electric current differential value Idf for the purpose of including (reflecting) the moving time of the opening-and-closing member or the moving distance of the opening-and-closing member in (to) the electric current differential value Idf when calculating the electric current differential value Idf. The electric current differential value calculation portion 16 serves as a part of a disturbance determination means. The electric current differential value Idf serves as a differential value.

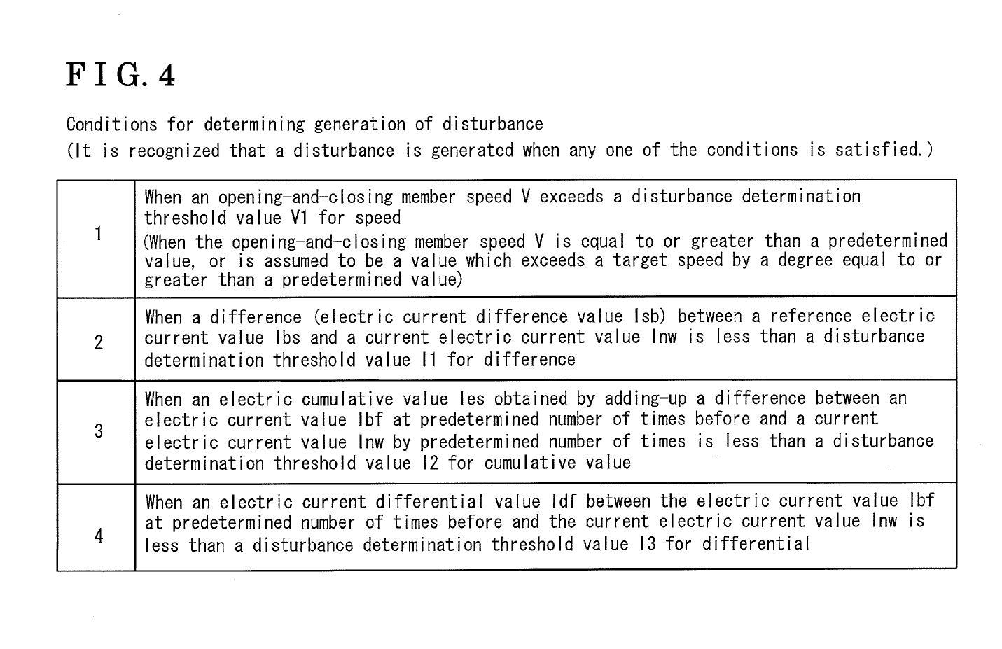

The opening-and-closing member control device 4 is provided with a disturbance determination portion 17 for determining whether a disturbance is generated during an opening/closing operation of the opening-and-closing member. As shown in FIG. 4, according to the embodiment, the disturbance determination portion 17 determines whether the disturbance is generated by monitoring the opening-and-closing member speed V or the motor electric current I, and recognizes that the disturbance is generated at the opening-and-closing member in a case where the opening-and-closing member speed V exceeds a predetermined value or a variation property of the motor electric current I is less than a predetermined value, thus to output a disturbance detection signal Sr to the entrapment detection portion 12. The disturbance determination portion 17 serves as a disturbance determination means.

According to the embodiment, the disturbance determination portion 17 determines whether the disturbance is generated by comparing the opening-and-closing member speed value Vx inputted from the opening-and-closing member information processing portion 6 and a disturbance determination threshold value V1 for speed. When the opening-and-closing member speed value Vx exceeds the disturbance determination threshold value V1 for speed, the disturbance determination portion 17 determines that the disturbance is generated, thus to output a first disturbance detection signal Sr1 to the entrapment detection portion 12. The disturbance determination portion 17 according to the embodiment recognizes that the disturbance is generated when the opening-and-closing member speed Vx is assumed to be equal to or greater than a predetermined value (i.e., absolute value) or when the opening-and-closing member speed value Vx is assumed to be a value which exceeds the target speed (trajectory planning) by a degree equal to or greater than a predetermined value (i.e., relative value) (that is, when a difference of the opening-and-closing member speed value Vx from the target speed is assumed to be equal to or greater than a predetermined level). The disturbance determination portion 17 continuously outputs the first disturbance detection signal Sr1 to the entrapment detection portion 12 while the opening-and-closing member speed value Vx detects the occurrence of the disturbance.

The disturbance determination portion 17 determines whether the disturbance is generated by comparing the electric current difference value Isb inputted from the electric current difference value calculation portion 14 and a disturbance determination threshold value I1 for difference which is a predetermined value. The disturbance determination portion 17 recognizes that the disturbance is generated at the opening-and-closing member when the electric current difference value Isb is less than the disturbance determination threshold value I1 for difference, thus to output a second disturbance detection signal Sr2 to the entrapment detection portion 12. The disturbance determination portion 17 continuously outputs the second disturbance detection signal Sr2 to the entrapment detection portion 12 while the electric current difference value Isb is less than the disturbance determination threshold value I1 for difference.

The disturbance determination portion 17 determines whether the disturbance is generated by comparing the electric cumulative value Ies inputted from the electric current cumulative value calculation portion 15 and a disturbance determination threshold value I2 for cumulative value as a predetermined value. The disturbance determination portion 17 recognizes that the disturbance is generated when the electric current cumulative value Ies is less than the disturbance determination threshold value I2 for cumulative value, thus to output a third disturbance detection signal Sr3 to the entrapment detection portion 12. The disturbance determination portion 17 continuously outputs the third disturbance detection signal Sr3 to the entrapment detection portion 12 while the electric cumulative value Ies is less than the disturbance determination threshold value I2 for cumulative value.

The disturbance determination portion 17 determines whether the disturbance is generated by comparing the electric current differential value Idf inputted from the electric current differential value calculation portion 16 and a disturbance determination threshold value I3 for differential as a predetermined value. The disturbance determination portion 17 recognizes that the disturbance is generated when the electric current differential value Idf is less than the disturbance determination threshold value I3 for differential, thus to output a fourth disturbance detection signal Sr4 to the entrapment detection portion 12. The disturbance determination portion 17 continuously outputs the fourth disturbance detection signal Sr4 to the entrapment detection portion 12 while the electric current differential value Idf is less than the disturbance determination threshold value I3 for differential.

The entrapment detection portion 12 is provided with an entrapment threshold value switching portion 18 (i.e., also refereed to as a threshold switching portion) for switching an entrapment threshold value Ik on the basis of a determination result by the disturbance determination portion 17. The entrapment threshold value switching portion 18 switches the entrapment threshold value Ik from the normal value to the higher value (the expanded value) when one of the disturbance detection signals Sr1 to Sr4 is inputted from the disturbance determination portion 17. Then, the entrapment threshold value switching portion 18 maintains the entrapment threshold value Ik at the expanded value during the disturbance detections signal Sr1 to Sr4 is inputted. Namely, the entrapment threshold value switching portion 18 maintains the entrapment threshold value Ik to be the expanded value at least during the disturbance is generated. The entrapment threshold value switching portion 18 serves as a threshold value switching means.

The entrapment threshold value switching portion 18 is provided with plural counters 19 which are applied when returning the entrapment threshold value Ik to the normal value. The counters 19 includes a first counter 19a for determining occurrence of entrapment by speed (1^{st} counter), a second counter 19b for determining occurrence of entrapment by difference value (2^{nd} counter), a third counter 19c for determining occurrence of entrapment by cumulative value (3^{rd} counter), and a fourth counter 19d for determining occurrence of entrapment by differential (4^{th} counter). The entrapment threshold value switching portion 18 measures an opening-and-closing member moving amount L (i.e., also referred to as a moving amount) after the disturbance is not detected or an elapsed time T (i.e., also referred to as time) after the disturbance is not detected using the counters 19a to 19d. When the opening-and-closing member moving amount L after the disturbance is not detected or the elapsed time T after the disturbance is not detected is assumed to be equal to or greater than a predetermined level, the entrapment threshold value switching portion 18 returns, or restore the entrapment threshold value Ik to the normal value.

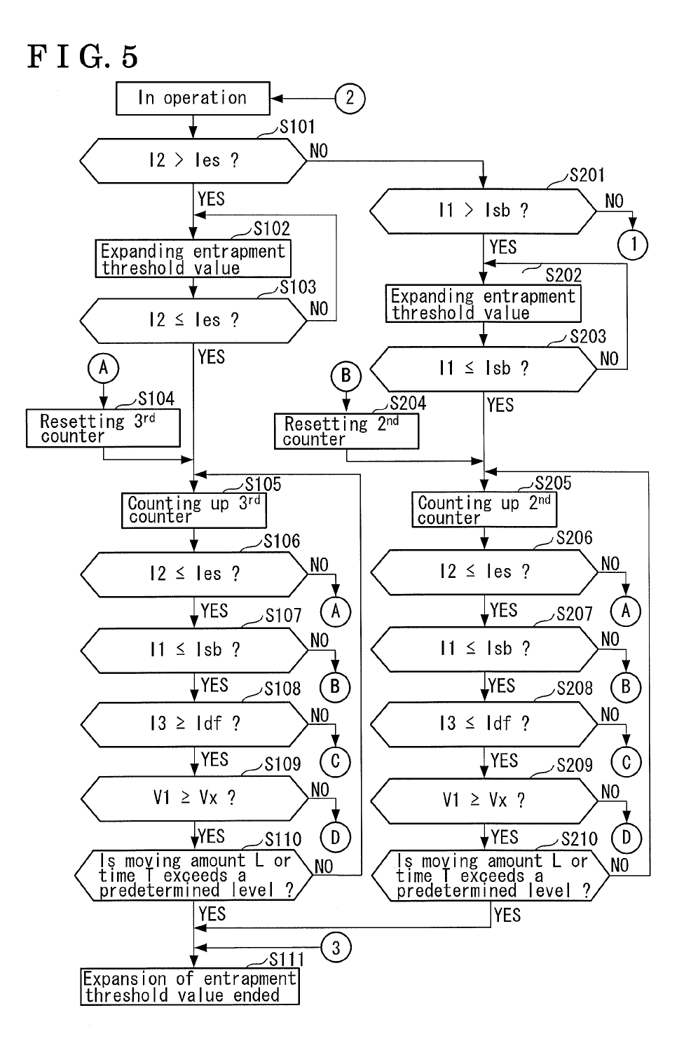

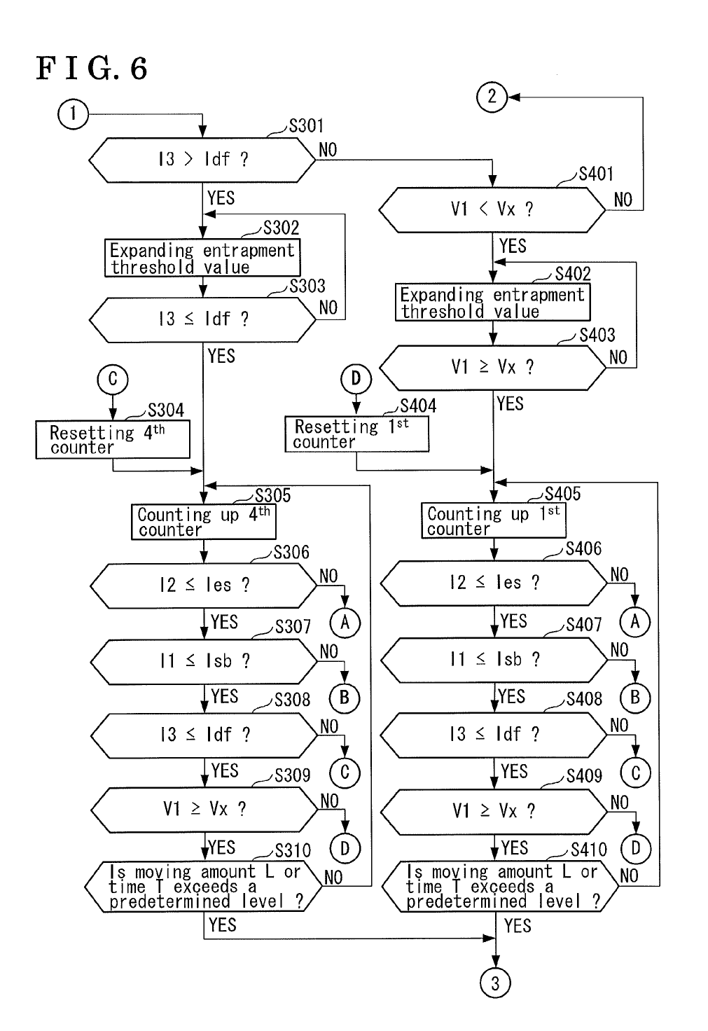

An operation of the entrapment threshold value switching function will be explained with reference to flowcharts shown in FIGS. 5 and 6. The transactions shown in flowcharts in FIGS. 5 and 6 are normally executed by the opening-and-closing member control device 4 during the operation of the opening-and-closing member (motor 2).

In Step S101, the disturbance determination portion 17 determines whether the electric current cumulative value Ies is less than the disturbance determination threshold value I2 for cumulative value (whether I2>Ies is satisfied). Namely, the disturbance determination portion 17 determines whether the disturbance is generated at the opening-and-closing member on the basis of changes in the cumulative value of the motor electric current I. Then, when the electric current cumulative value Ies is less than the disturbance determination threshold value I2 (I2>Ies is satisfied), the transaction advances to Step S102. When the electric current cumulative value Ies is not less than the disturbance determination threshold value I2 (I2>Ies is not satisfied), the transaction advances to Step S201. The disturbance determination portion 17 outputs the third disturbance detection signal Sr3 to the entrapment threshold value switching portion 18 when it is determined that the electric current cumulative value Ies is less than the disturbance determination threshold value I2 (when I2>Ies is satisfied).

In Step S201, the disturbance determination portion 17 determines whether the electric current difference value Isb is less than the disturbance determination threshold value I1 for difference (whether I1>Isb is satisfied). Namely, the disturbance determination portion 17 determines whether the disturbance is generated at the opening-and-closing member on the basis of the changes in the difference value of the motor electric current I. When the electric current difference value Isb is less than the disturbance determination threshold value I1 (when I1>Isb is satisfied), the transaction advances to Step S202. When the electric current difference value Isb is not less than the disturbance determination threshold value I1 (when I1>Isb is not satisfied), the transaction advances to Step S301. The disturbance determination portion 17 outputs the second disturbance detection signal Sr2 to the entrapment threshold value switching portion 18 when it is determined that the electric current difference value Isb is less than the disturbance determination threshold value I1 (when I1>Isb is satisfied).

In Step S301, the disturbance determination portion 17 determines whether the electric current differential value Idf is less than the disturbance determination threshold value I3 for differential (whether I3>Idf is satisfied). Namely, the disturbance determination portion 17 determines whether the disturbance is generated at the opening-and-closing member on the basis of the changes in the differential value of the motor electric current I. Then, when the electric current differential value Idf is less than the disturbance determination threshold value I3 for differential (when I3>Idf is satisfied), the transaction advances to Step S302. When the electric current differential value Idf is not less than the disturbance determination threshold value I3 for differential (when I3>Idf is not satisfied), the transaction advances to Step S401. The disturbance determination portion 17 outputs the fourth disturbance detection signal Sr4 to the entrapment threshold value switching portion 18 when the electric current differential value Idf is less than the disturbance determination threshold value I3 for differential (when I3>Idf is satisfied).

In Step S401, the disturbance determination portion 17 determines whether the opening-and-closing member speed value Vx exceeds the disturbance determination threshold value V1 for speed (whether V1<Vx is satisfied). Namely, the disturbance determination portion 17 determines whether the disturbance is generated at the opening-and-closing member on the basis of the changes in speed of the opening-and-closing member. When the opening-and-closing member speed value Vx exceeds the disturbance determination threshold value V1 for speed (when V1<Vx is satisfied), the transaction advances to Step S402. When the opening-and-closing member speed value Vx does not exceed the disturbance determination threshold value V1 for speed (when V1<Vx is not satisfied), the transaction returns to the beginning (i.e., “in operation” in FIG. 5). The disturbance determination portion 17 outputs the first disturbance detection signal Sr1 to the entrapment threshold value switching portion 18 when it is determined that opening-and-closing member speed value Vx exceeds the disturbance determination threshold value V1 for speed (when V1<Vx is satisfied).

In Steps S102, S202, S302, S402, the entrapment threshold value switching portion 18 switches the entrapment threshold value Ik from the normal value to the expanded value, that is, the higher value, when one of the disturbance detection signals Sr1 to Sr4 is inputted. The entrapment threshold value switching portion 18 maintains the entrapment threshold value Ik to be the expanded value while at least one of the disturbance detection signals Sr1, Sr2, Sr3, Sr4 is inputted thereto.

In Step S103, the disturbance determination portion 17 determines whether the electric current cumulative value Ies is assumed to be equal to or greater than the disturbance determination threshold value I2 for cumulative value (whether I2≦Ies is satisfied). Namely, the disturbance determination portion 17 determines whether the disturbance of the opening-and-closing member is subsided on the basis of the changes in the cumulative value of the motor electric current I. The disturbance determination portion 17 stops outputting the third disturbance detection signal Sr3 to the entrapment threshold value switching portion 18 when the electric cumulative value Ies is assumed to be equal to or greater than the disturbance determination threshold value I2 for cumulative value (when I2≦Ies is satisfied). Thus, the transaction advances to Step S105 when the determination at Step S103 is positive. On the other hand, when the electric cumulative value Ies is not assumed to be equal to or greater than the disturbance determination threshold value I2 for cumulative value (when I2≦Ies is not satisfied), the disturbance determination portion 17 continues to output the third disturbance detection signal Sr3 to the entrapment threshold value switching portion 18. Thus, when the determination at Step S103 is negative, the transaction returns to Step S102 so that the entrapment threshold value switching portion 18 maintains the entrapment threshold value Ik to be the expanded value.

In Step S203, the disturbance determination portion 17 determines whether the electric current difference value Isb is assumed to be equal to or greater than the disturbance determination threshold value I1 for difference (whether I1≦Isb is satisfied). Namely, the disturbance determination portion 17 determines whether the disturbance of the opening-and-closing member is subsided on the basis of the changes in the difference value of the motor electric current I. When the electric current difference value Isb is assumed to be equal to or greater than the disturbance determination threshold value I1 for difference (when I1≦Isb is satisfied), the disturbance determination portion 17 stops outputting the second disturbance detection signal Sr2 to the entrapment threshold value switching portion 18. Thus, when the determination at Step S203 is positive, the transaction advances to Step S205. On the other hand, when the electric current difference value Isb is not assumed to be equal to or greater than the disturbance determination threshold value I1 for difference (when I1≦Isb is not satisfied), the disturbance determination portion 17 continues to output the second disturbance detection signal Sr2 to the entrapment threshold value switching portion 18. Thus, when the determination at Step S203 is negative, the transaction returns to Step S202, and the entrapment threshold value switching portion 18 maintains the entrapment threshold value Ik to be the expanded value.

In Step S303, the disturbance determination portion 17 determines whether the electric current differential value Idf is assumed to be equal to or greater than the disturbance determination threshold value I3 for differential (whether I3≦Idf is satisfied). Namely, the disturbance determination portion 17 determines whether the disturbance of the opening-and-closing member is subsided by the changes in differential value of the motor electric current I. When the electric current differential value Idf is assumed to be equal to or greater than the disturbance determination threshold value I3 for differential (when I3≦Idf is satisfied), the disturbance determination portion 17 stops outputting the fourth disturbance detection signal Sr4 to the entrapment threshold value switching portion 18. Thus, when the determination at Step S303 is positive, the transaction advances to Step S305. On the other hand, when the electric current differential value Idf is not assumed to be equal to or greater than the disturbance determination threshold value I3 for differential (when I3≦Idf is not satisfied), the disturbance determination portion 17 continues to output the fourth disturbance detection signal Sr4 to the entrapment threshold value switching portion 18. Thus, when the determination at Step S303 is negative, the transaction returns to Step S302, and the entrapment threshold value switching portion 18 maintains the entrapment threshold value Ik to be the expanded value.

In Step S403, the disturbance determination portion 17 determines whether the opening-and-closing member speed value Vx is assumed to be equal to or less than the disturbance determination threshold value V1 for speed (whether V1≧Vx is satisfied). Namely, the disturbance determination portion 17 determines whether the disturbance of the opening-and-closing member is subsided on the basis of the changes in the opening-and-closing member speed V. Then, when the opening-and-closing member speed value Vx is assumed to be equal to or less than the disturbance determination threshold value V1 for speed (when V1≧Vx is satisfied), the disturbance determination portion 17 stops outputting the first disturbance detection signal Sr1 to the entrapment threshold value switching portion 18. Thus, when the determination at Step S403 is positive, the transaction advances to Step S405. On the other hand, when the opening-and-closing member speed value Vx is not assumed to be equal to or less than the disturbance determination threshold value V1 for speed (when V1≧Vx is not satisfied), the disturbance determination portion 17 continues to output the first disturbance detection signal Sr1 to the entrapment threshold value switching portion 18. Thus, when the determination in Step S403 is negative, the transaction returns to Step S402, and the entrapment threshold value switching portion 18 maintains the entrapment threshold value Ik to be the expanded value.

In Step S105, the entrapment threshold value switching portion 18 counts up the third counter 19c. Namely, the entrapment threshold value switching portion 18 counts the opening-and-closing member moving amount L or the elapsed time T, by means of the third counter 19c, after recognizing, or determining that the disturbance of the opening-and-closing member is subsided on the basis of the changes in the cumulative value. The third counter 19c starts from a counter value of zero (0) and the counter value increments by one every time Step S105 is executed.

In Step S106, the entrapment threshold value switching portion 18 re-determines whether I2≦Ies is satisfied in order to verify whether the motor electric current I is not assumed to be below the disturbance determination threshold value I2 for cumulative value again (another time) during the counting operation by the third counter 19c. Then, when I2≦Ies is satisfied, the transaction advances to Step S107. When I2≦Ies is not satisfied, the transaction advances to Step S104.

In Step S104, the entrapment threshold value switching portion 18 resets the third counter 19c. Namely, because the disturbance is generated at the opening-and-closing member again (another time), the entrapment threshold value switching portion 18 restarts the counting by the third counter 19c.

In Step S107, the entrapment threshold value switching portion 18 re-determines whether I1≦Isb is satisfied in order to verify whether the motor electric current I is not assumed to be below the disturbance determination threshold value I1 for difference again (another time) during the counting operation by the third counter 19c. When I1≦Isb is satisfied, the transaction advances to Step S108. On the other hand, when I1≦Isb is not satisfied, the transaction advances to Step S204 to start measuring the opening-and-closing member moving amount L or the elapsed time T using the second counter 19b.

In Step S108, the entrapment threshold value switching portion 18 re-determines whether I3≦Idf is satisfied in order to verify whether the motor electric current I is not assumed to be below the disturbance determination threshold value I3 for differential again (another time) during the counting operation by the third counter 19c. Then, when I3≦Idf is satisfied, the transaction advances to Step S109. On the other hand, when I3≦Idf is not satisfied, the transaction advances to Step S304 to start measuring the opening-and-closing member moving amount L or the elapsed time T using the fourth counter 19d.

In Step S109, the entrapment threshold value switching portion 18 re-determines whether V1≧Vx is satisfied in order to verify whether the opening-and-closing member speed value Vx does not exceed the disturbance determination threshold value V1 for speed again (another time) during the counting operation by the third counter 19c. Then, when V1≧Vx is satisfied, the transaction advances to Step S110. On the other hand, when V1≧Vx is not satisfied, the transaction advances to Step S404 to start the measurement of the opening-and-closing member moving amount L or the elapsed time T using the first counter 19a.

In Step S110, the entrapment threshold value switching portion 18 determines whether the third counter 19c reaches a counter upper limit value. Namely, in Step S110, the entrapment threshold value switching portion 18 determines whether either the opening-and-closing member moving amount L or the elapsed time T after it is recognized, or determined that the disturbance is subsided on the basis of the changes in cumulative value is assumed to be equal to or greater than the predetermined level. In those circumstances, in a case where the third counter 19c reaches the counter upper limit, the transaction advances to Step S111. On the other hand, in a case where the third counter 19c does not reach the counter upper limit value, the transaction returns to Step S105 to repeat the transactions of Step S105 to S110 until the third counter 19c reaches the counter upper limit.

In Step S111, the entrapment threshold value switching portion 18 changes the entrapment threshold value Ik from the expanded value to the normal value. Thus, the entrapment threshold value Ik returns, or restore to the normal value. Transactions in Steps S204 to S210, transactions in Steps S304 to 310, and transactions in Steps S404 to S410 are basically the same to the Steps S104 to S110 except that the counters to be applied are different. Thus, explanations for the transactions in Steps S204 to S210, in Steps S304 to 310, and in Steps S404 to 5410 will not be repeated.

As forgoing, according to the construction of the embodiment, whether the disturbance is generated at the opening-and-closing member is determined on the basis of the changes in either the opening-and-closing member speed V or the motor electric current I, and the entrapment threshold value Ik is expanded so as to avoid the motor electric current I from exceeding the entrapment threshold value Ik when the disturbance is generated. Thus, because an increase in the electric current because of the disturbance is not detected as the occurrence of the entrapment even if the disturbance is generated at the opening-and-closing member, a precision of the entrapment detection can be ensured.

Further, according to the construction of the embodiment, whether the disturbance is generated is constantly monitored during the operation of the opening-and-closing member. Thus, even when the disturbance is generated at the opening-and-closing member which is in operation, the entrapment threshold value Ik can be switched to the expanded value every time the disturbance is generated. Because the entrapment threshold value Ik can be switched to the expanded value at any time even during the opening-and-closing member is in operation, the effects for preventing erroneous detection of the entrapment is enhanced. Further, because the entrapment threshold value Ik is switched to the expanded value only when the disturbance is generated, the entrapment threshold value Ik can be switched to the expanded value only when it is necessary.

According to the construction of the embodiment, the following advantages and effects are attained.

First, in a case where the generation of the disturbance is confirmed while monitoring whether the disturbance is generated at the opening-and-closing member which is in operation, the entrapment threshold value Ik is switched from the normal value to the expanded value. Thus, when the disturbance is generated at the opening-and-closing member, even if the motor electric current I increases unintentionally by the disturbance, because the entrapment threshold value Ik is switched from the normal value to the expanded value at the timing of the generation of the disturbance, the motor electric current I does not exceed the entrapment threshold value Ik. Accordingly, even if an increase in the motor electric current I is caused due to the disturbance at the opening-and-closing member, the disturbance is not detected as the generation of the entrapment, thus enhancing the prevention of the erroneous detection of the entrapment. Further, because the generation of the disturbance is constantly monitored during the opening-and-closing member is operated, the entrapment threshold value can be switched to the expanded value only at the timing when it is necessary to switch the threshold value, that is, when the disturbance is generated.

Second, because the entrapment threshold value Ik is switched from the normal value to the expanded value when the disturbance is generated during the opening-and-closing member is in operation, the entrapment threshold value Ik can be switched to the expanded value only at the timing when the disturbance is generated. Thus, because it is not necessary to adopt the transaction which, for example, sets the entrapment threshold value Ik to be higher constantly during the opening operation of the opening-and-closing member, a state that an entrapment load is always increased in a specified range, that is, in a range that the opening-and-closing member moves to open or close can be avoided.

Third, when the opening-and-closing member speed V exceeds the predetermined value or when the opening-and-closing member exceeds the target speed by a predetermined value, that the disturbance is generated at the opening-and-closing member is determined. Thus, according to the construction of the embodiment, whether the disturbance is generated can be determined by a simple transaction by comparing the speed.

Fourth, when a difference (electric current difference value Isb) between the reference electric current value Ibs and the current electric current value Inw is calculated and the electric current difference value Isb is below the predetermined value, it is determined that the disturbance is generated at the opening-and-closing member. Meanwhile, the electric current difference value Isb has a property exhibiting a detectable change in value (a change with a certain level) provided that the disturbance is applied slowly to the opening-and-closing member and provided that the disturbance is abruptly applied to the opening-and-closing member. Namely, the electric current difference value Isb has a property between the electric current cumulative value Ies and the electric current differential value Idf. Thus, by determining the disturbance using the electric current difference value Isb, the disturbance applied to the opening-and-closing member can be favorably detected in a balanced manner.

Fifth, when a difference between the electric current value Ibf at predetermined number of times before and the current electric current value Inw is added-up, or integrated by the predetermined number of times to calculate the electric current cumulative value Ies and when the electric current cumulative value Ies is below the predetermined value, it is determined that the disturbance is generated at the opening-and-closing member. The electric current cumulative value Ies has a property that shows detectable changes in value (i.e., sharp change in value) when an external force (disturbance) is applied to the opening-and-closing member slowly. Thus, by determining the generation of the disturbance using the electric current cumulative value Ies, the disturbance slowly applied to the opening-and-closing member can be detected with high precision.

Sixth, when calculating the electric current differential value Idf by obtaining a rate of change between the electric current value Ibf at predetermined number of times before and the current electric current value Inw (i.e., obtaining a differential value) and when the electric current differential value Idf is below the predetermined value, it is determined that the disturbance is generated at the opening-and-closing member. The electric current differential value Idf has a property that shows detectable changes in value (i.e., sharp change in value) when an external force (disturbance) is applied to the opening-and-closing member abruptly (instantaneously). Thus, by determining whether disturbance is generated using the electric current differential value Idf, the disturbance abruptly applied to the opening-and-closing member can be detected with high precision.

Seventh, four parameters, that is, the opening-and-closing member speed V, the electric current difference value Isb, the electric current cumulative value Ies, and the electric current differential value Idf, are constantly monitored and it is determined that the disturbance is generated when at least one of the mentioned parameters is out of respectively provided predetermined values. Thus, the precision to determined the generation of the disturbance is enhanced.

Eighth, when it is determined that the disturbance is subsided, the entrapment threshold value Ik is not returned to the normal value immediately, and the entrapment threshold value Ik is returned to the normal value when either the opening-and-closing member moving amount L or the elapsed time T after it is determined that the disturbance is subsided is assumed to be equal to or greater than the predetermined level. Thus, because the entrapment threshold value Ik is returned to the normal value after the opening-and-closing member is stabilized after the disturbance is subsided, the entrapment threshold value Ik can be returned to the normal value at an optimum timing.

Ninth, when it is determined that the disturbance is subsided at all of the parameters, that is, the opening-and-closing member speed V, the electric current difference value Isb, the electric current cumulative value Ies, and the electric current differential value Idf during determining whether either the opening-and-closing member moving amount L or the elapsed time T is assumed to be equal to or greater than the predetermined level, the entrapment threshold value Ik is returned to the normal value. Thus, the entrapment threshold value Ik can be changed from the expanded value back to the normal value when the opening-and-closing member is securely stabilized.

The construction of the opening-and-closing member control device is not limited to the foregoing construction, and may be changed as the followings.

The expanded value of the entrapment threshold value Ik is not limited to be the same value at all of the transactions including the determination transaction using the opening-and-closing member speed V, the determination transaction using the electric current difference value Isb, the determination transaction using the electric current cumulative value Ies, and the determination transaction using the electric current differential value Idf. That is, the expanded value may be set to have different values (may be different) at each of the determination transactions.

The expanded value of the entrapment threshold value Ik is not limited to a fixed value. Alternatively, for example, the expanded value may be a variable value which is set at different values in accordance with the degree of the disturbance. The opening-closing state detection sensor 5 is not limited to the encoder which is built in the motor 2. Alternatively, for example, a sensor for detecting the movement of the opening-and-closing member per se may be applied.

The electric signal applied for the disturbance determination is not limited to the motor electric current I. Alternatively, for example, a motor electric voltage may be applied as the electric signal for the disturbance determination. An operation speed of the opening-and-closing member is not limited to the speed (opening-and-closing member speed V). Alternatively, for example, an acceleration may be applied as the operation speed of the opening-and-closing member.

The disturbance determination is not limited to the transaction in which all of the parameters including the opening-and-closing member speed V, the electric current difference value Isb, the electric current cumulative value Ies, and the electric current differential value Idf are applied. For example, a transaction in which at least one of the parameters including the opening-and-closing member speed V, the electric current difference value Isb, the electric current cumulative value Ies, and the electric current differential value Idf may be applied for the disturbance determination transaction.

The driving device is not limited to the motor. For example, another actuator, for example, a solenoid, may be applied as the driving device. The opening-and-closing member is not limited to a slide door or a backdoor (a door at the back of a vehicle), and another member may be applied as the opening-and-closing member.

The electric signal is not limited to the electric current (motor electric current I), and may be replaced by a voltage applied to the motor (motor electric voltage). An application of the opening-and-closing member control device 4 is not limited to a vehicle. For example, the opening-and-closing member control device 4 may be applied to other apparatuses and devices.

A method for the disturbance determination is not limited to the methods using the opening-and-closing member speed V, the electric current difference value Isb, the electric current cumulative value Ies, and the electric current differential value Idf. As long as being able to recognize, or determine the disturbance, a method for the disturbance determination is changeable.

According to the construction of the embodiment, the opening-and-closing member control device (4) for controlling the driving device (motor 2) to operate an opening-and-closing member in accordance with the target speed, which includes the detection means (electric current detection portion 11) detecting an operational state of the driving device (motor 2) during the control, the disturbance determination means (6, 14, 15, 16, 17) for determining whether a disturbance is generated at the opening-and-closing member, which is applied in the same direction to an operating direction of the opening-and-closing member during an opening-closing operation of the opening-and-closing member, by monitoring at least one of a change in an electric signal (motor electric current I) and in an operation speed (opening-and-closing member speed V) of the opening-and-closing member generated relative to the target speed, and the threshold value changing means (entrapment threshold value switching portion 18) for switching the entrapment threshold value (Ik) when the disturbance determination means (6, 14, 15, 16, 17) determines that the disturbance is generated. Whether an external object is entrapped at the opening-and-closing member is detectable by comparing an electric signal obtained by the detection means (electric current detection portion 11) and the entrapment threshold value (Ik).

According the construction of the embodiment, whether the disturbance is generated at the opening-and-closing member during the operation is monitored, and when the generation of the disturbance is confirmed, the entrapment threshold value (Ik) is switched from the normal value. Thus, provided that a disturbance is generated at the opening-and-closing member and even if the electric signal (motor electric current I) which is to be applied for determining the entrapment changes, because the entrapment threshold value (Ik) is switched from the normal value at the timing that the disturbance is generated, the electric signal (motor electric current I) does not exceed the entrapment threshold value. Accordingly, even if the level of the electric signal (motor electric current I) is changed due to the disturbance, the change in the electric signal (motor electric current I) is not detected as the entrapment, thus a performance for preventing erroneous detection of the entrapment is enhanced. Further, because whether the disturbance is generated is constantly monitored during the operation of the opening-and-closing member, the entrapment threshold value can be switched only at a timing when the changes in the threshold value is really necessary, that is, when the disturbance is generated.

According to the construction of the embodiment, the disturbance determination means (disturbance determination portion 17) recognizes that the disturbance is generated when the operation speed (opening-and-closing member speed V) of the opening-and-closing member exceeds a predetermined value or when the operation speed (opening-and-closing member speed V) of the opening-and-closing member exceeds the target speed by a predetermined value.

According to the construction of the embodiment, whether the disturbance is generated is determined (disturbance determination) with a simple transaction, that is, by comparing speed.

According to the construction of the embodiment, the disturbance determination means (14, 17) calculates a difference (electric current difference value Isb) between a reference electric signal (reference electric current value Ibs) that the electric signal (I) is assumed to be during a stable operation of the opening-and-closing member and a current electric signal (current electric current value Inw), and determines whether the disturbance is generated based on the difference (electric current difference value Isb) between the reference electric signal (reference electric current value Ibs) and the current electric signal (current electric current value Inw).

According to the construction of the embodiment, the difference (electric current difference value Isb) between the reference electric signal (reference electric current value Ibs) and the current electric signal (current electric current value Inw) has a property that exhibits a detectable change (a change with a certain level) irrespective of a manner of application of the disturbance, that is, irrespective of whether the disturbance is slowly applied to the opening-and-closing member or whether the disturbance is abruptly applied to the opening-and-closing member. Thus, by determining whether the disturbance is generated using the difference (electric current difference value Isb), the disturbance applied to the opening-and-closing member can be favorably detected in a balanced manner.

According to the construction of the embodiment, the disturbance determination means (15, 17) adds-up a difference between an electric signal (Ibf) at predetermined timing before (electric current value Ibf at predetermined number of times before) and a current electric signal (current electric current value Inw), and determines whether the disturbance is generated based on a cumulative value (electric cumulative value Ies) obtained by the adding-up of the difference between electric signal (Ibf) at predetermined timing before (electric current value Ibf at predetermined number of times before) and the current electric signal (current electric current value Inw).

According to the construction of the embodiment, the cumulative value (electric cumulative value Ies) which is attained by adding-up the difference between the electric signal at predetermined timing before (electric current value Ibf at predetermined number of times before) and the current electric signal (current electric current value Inw) by the predetermined number of times has a property that shows detectable changes in value (i.e., sharp change in value) when the disturbance is slowly applied to the opening-and-closing member. Thus, by determining whether the disturbance is generated using the cumulative value (electric cumulative value Ies), the disturbance slowly applied to the opening-and-closing member can be detected with high precision.

According to the construction of the embodiment, the disturbance determination means (16, 17) calculates a differential value (electric current differential value Idf) between an electric signal (Ibf) at predetermined timing before (electric current value Ibf at predetermined number of times before) and a current electric signal (current electric current value Inw), and determines whether the disturbance is generated based on the differential value (electric current differential value Idf).

According to the construction of the embodiment, the differential value (electric current differential value Idf) between the electric signal at predetermined timing before (electric current value Ibf at predetermined number of times before) and the current electric signal (current electric current value Inw) has a property that shows detectable changes in value (i.e., sharp change in value) when the disturbance is applied to the opening-and-closing member abruptly (instantaneously). Thus, by determining whether the disturbance is generated using the differential value (electric current differential value Idf), the disturbance abruptly applied to the opening-and-closing member can be detected with high precision.

According to the construction of the embodiment, the disturbance determination means (6, 14, 15, 16, 17) determines whether the disturbance is generated on the basis of at least one of a transaction for determining a generation of the disturbance by comparing the operation speed (opening-and-closing member speed V) of the opening-and-closing member to a predetermined value, a transaction for calculating a difference between a reference electric signal (reference electric current value Ibs) that the electric signal (I) is assumed to be during a stable operation of the opening-and-closing member and a current electric signal (current electric current value Inw) and for determining whether the disturbance is generated based on the difference, a transaction for obtaining a cumulative value by adding-up a difference between an electric signal (Ibf) at predetermined timing before (electric current value Ibf at predetermined number of times before) and a current electric signal (current electric current value Inw) and for determining whether the disturbance is generated based on the cumulative value (electric current cumulative value Ies), and a transaction for calculating a differential value (electric current differential value Idf) between an electric signal (Ibf) at predetermined timing before (electric current value Ibf at predetermined number of times before) and a current electric signal (current electric current value Inw) and for determining whether the disturbance is generated based on the differential value (electric current differential value Idf).

According to the construction of the embodiment, the disturbance can be determined with high precision.

According to the construction of the embodiment, the threshold value changing means (entrapment threshold value switching portion 18) returns the entrapment threshold value (Ik) from the expanded value to the normal value when either a moving amount (opening-and-closing member moving amount L) or an elapsed time (T) is assumed to be equal to or greater than a predetermined level after the disturbance determination means (disturbance determination portion 17) recognizes that the disturbance is subsided.

According to the construction of the embodiment, the entrapment threshold value (Ik) is not returned to the normal value immediately after the disturbance is subsided and is returned to the normal value when the moving amount (L) of the opening-and-closing member or the elapsed time (T) after determining that the disturbance is subsided is assumed to be equal to or greater than the predetermined level. Thus, because the entrapment threshold value (Ik) is changed to the original value after the opening-and-closing member is stabilized after the disturbance is subsided, the entrapment threshold value (Ik) can be changed to the normal value at an optimum timing.

According to the construction of the embodiment, the threshold value changing means (entrapment threshold value switching portion 18) returns the entrapment threshold value (Ik) to a normal value when it is determined that the disturbance is subsided by all of a transaction for determining a generation of the disturbance by comparing the operation speed (opening-and-closing member speed V) of the opening-and-closing member to a predetermined value, a transaction for determining a generation of the disturbance based on a difference (electric current difference value Isb) between a reference electric signal (reference electric current value Ibs) that the electric signal (I) is assumed to be during a stable operation of the opening-and-closing member and a current electric signal (current electric current value Inw), a transaction for determining a generation of the disturbance based on a cumulative value (electric cumulative value Ies) obtained by adding-up a difference between an electric signal (Ibf) at predetermined timing before and a current electric signal (Inw), and a transaction for determining a generation of the disturbance based on a differential value (Idf) between an electric signal (Ibf) at predetermined timing before (electric current value Ibf at predetermined number of times before) and a current electric signal (current electric current value Inw).

According to the construction of the embodiment, because the subsiding of the disturbance can be determined with high precision, the entrapment threshold value can be changed back to the normal value at further appropriate timing.

According to the construction of the embodiment, the entrapment threshold value can be switched only at an appropriate timing.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An opening-and-closing member control device for controlling a driving device to operate an opening-and-closing member in accordance with a target speed, comprising:
a detection means detecting an operational state of the driving device during the control;
a disturbance determination means for determining whether a disturbance is generated at the opening-and-closing member, which is applied in the same direction to an operating direction of the opening-and-closing member during an opening-closing operation of the opening-and-closing member, by monitoring at least one of a change in an electric signal and in an operation speed of the opening-and-closing member generated relative to the target speed; and
a threshold value changing means for switching an entrapment threshold value when the disturbance determination means determines that the disturbance is generated;
wherein whether an external object is entrapped at the opening-and-closing member is detectable by comparing an electric signal obtained by the detection means and the entrapment threshold value.

2. The opening-and-closing member control device according to claim 1, wherein the disturbance determination means recognizes that the disturbance is generated when the operation speed of the opening-and-closing member exceeds a predetermined value or when the operation speed of the opening-and-closing member exceeds the target speed by a predetermined value.

3. The opening-and-closing member control device according claim 1, wherein the disturbance determination means calculates a difference between a reference electric signal that the electric signal is assumed to be during a stable operation of the opening-and-closing member and a current electric signal, and determines whether the disturbance is generated based on the difference between the reference electric signal and the current electric signal.

4. The opening-and-closing member control device according to claim 1, wherein the disturbance determination means adds-up a difference between an electric signal at predetermined timing before and a current electric signal, and determines whether the disturbance is generated based on a cumulative value obtained by the adding-up of the difference between electric signal at predetermined timing before and the current electric signal.

5. The opening-and-closing member control device according to claim 1, wherein the disturbance determination means calculates a differential value between an electric signal at predetermined timing before and a current electric signal, and determines whether the disturbance is generated based on the differential value.

6. The opening-and-closing member control device according to claim 1, wherein the disturbance determination means determines whether the disturbance is generated on the basis of at least one of a transaction for determining a generation of the disturbance by comparing the operation speed of the opening-and-closing member to a predetermined value, a transaction for calculating a difference between a reference electric signal that the electric signal is assumed to be during a stable operation of the opening-and-closing member and a current electric signal and for determining whether the disturbance is generated based on the difference, a transaction for obtaining a cumulative value by adding-up a difference between an electric signal at predetermined timing before and a current electric signal and for determining whether the disturbance is generated based on the cumulative value, and a transaction for calculating a differential value between an electric signal at predetermined timing before and a current electric signal and for determining whether the disturbance is generated based on the differential value.

7. The opening-and-closing member control device according to claim 1, wherein the threshold value changing means returns the entrapment threshold value from the expanded value to the normal value when either a moving amount or an elapsed time is assumed to be equal to or greater than a predetermined level after the disturbance determination means recognizes that the disturbance is subsided.

8. The opening-and-closing member control device according to claim 1, wherein the threshold value changing means returns the entrapment threshold value to a normal value when it is determined that the disturbance is subsided by all of a transaction for determining a generation of the disturbance by comparing the operation speed of the opening-and-closing member to a predetermined value, a transaction for determining a generation of the disturbance based on a difference between a reference electric signal that the electric signal is assumed to be during a stable operation of the opening-and-closing member and a current electric signal, a transaction for determining a generation of the disturbance based on a cumulative value obtained by adding-up a difference between an electric signal at predetermined timing before and a current electric signal, and a transaction for determining a generation of the disturbance based on a differential value between an electric signal at predetermined timing before and a current electric signal.

9. An opening-and-closing member control device for controlling a driving device to cause an opening-and-closing member to operate in accordance with a target speed, comprising:
a detection means detecting an operational state of the driving device during the control;
a disturbance determination means for determining whether a disturbance is generated at the opening-and-closing member, which is applied in the same direction to an operating direction of the opening-and-closing member during an opening-closing operation of the opening-and-closing member, by monitoring at least one of a change in an electric signal and in an operation speed of the opening-and-closing member generated relative to the target speed; and
a threshold value changing means for switching an entrapment threshold value when the disturbance determination means determines that the disturbance is generated;
wherein whether an external object is entrapped at the opening-and-closing member is detectable by comparing an electric signal obtained by the detection means and the entrapment threshold value.
